(19) United States
(12) Patent Application Publication
(10) Pub. No.: US 2025/0311830 A1
(43) Pub. Date: Oct. 9, 2025

(54) Wax Warming Appliance

(71) Applicant: Meghan Vanderford, Sacramento, CA (US)

(72) Inventor: Meghan Vanderford, Sacramento, CA (US)

(21) Appl. No.: 18/628,752

(22) Filed: Apr. 7, 2024

(51) Int. Cl. A45D 26/00; G01G 23/36; G01G 23/37; G05D 23/24; G06F 3/0484; G06F 3/04886; H05B 1/02

(52) U.S. Cl. CPC A45D 26/0014; G01G 23/3735; G05D 23/24; G06F 3/0484; G06F 3/04886; H05B 1/0244; A45D 2200/155; G01G 23/361

(57) ABSTRACT

An improved portable wax warming appliance that is used by an esthetician to melt wax and control the melted wax temperature for the purpose of removing body hair from an individual. The wax warming appliance can be controlled in situ and remotely by a user. The improved portable wax warming appliance can accurately show and communicate the amount, the consistency and the temperature of wax contained in the warming pot. The wax warming appliance can be preset to a variety of temperatures to accommodate different types of wax or set to a cleaning mode temperature. The wax warming appliance includes a holder to safely hold the appliance's hot lid while the user is in the process of removing or adding wax.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable devices that assist estheticians and more specifically to a portable wax warming appliance that is used to melt wax for application of wax to the skin and hair of a person to aid in the hair removal process.

Wax warming devices are currently used by estheticians to melt a pot of wax. The devices currently used have a housing that encloses a metal pot that has a heating element in close proximity to the base of the pot. A temperature adjustment knob located on the outside of the housing allows a user to select an ideal temperature depending on the type of wax being used within the heated pot.

However, none of the wax warming pots currently available in the market allow the user to turn on the heating element remotely via an internet connection. This feature would be very helpful since the wax within the pot can take one hour or more to heat up to ideal use temperature. By turning on the heating element remotely, the wax warming appliance can start heating up wax while the user is in transit to the end use site. Additionally, there is no way to determine how much wax is in the pot other than by basic visual inspection, which is not very accurate. Furthermore, current wax warmer devices have no way to preset temperatures based on what type of wax is being used or by whether the wax warming device needs to be in a cleaning mode. Finally, current wax warming devices do not have a place to safely store the hot lid of the device while the esthetician is making use of the hot wax contained within the heated pot.

### BRIEF SUMMARY OF THE INSTANT INVENTION

Presented in the instant invention is an improved portable self-contained wax warming appliance that is primarily used by estheticians to melt wax for the purpose of removing body hair from an individual.

An object of the invention is to provide a wax warming appliance that can be turned on remotely by a user.

Another object of the invention is to provide a wax warming appliance that allows the user to accurately know the amount of wax contained in the warming pot.

Another object of the invention is to provide a wax warming appliance that allows the user to preset a variety of temperatures to accommodate different types of wax or to set to cleaning mode temperature.

Another object of the invention is to provide a wax warming appliance that can be controlled locally, in situ, and remotely and to be able to obtain the status of the wax warming appliance locally and remotely.

Another object of the invention is to provide a wax warming appliance that includes a holder for the appliance's to safely hold a hot lid while the user is in the process of removing or adding wax.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a portable wax warming appliance including an outer housing retaining a metal wax holding pot, a heating element, a temperature sensor, a touch screen control panel, a plurality of transducers to measure the weight of the wax in the holding pot, a microcontroller based control system and a removable lid; the wax holding pot being located within said housing and covered by a removable lid; the heating element being located in close proximity to the underside of the wax holding pot; the touch screen control panel located on the outer surface of the outer housing; the control system located behind the touch screen control panel; a communication system unit, facilitating wireless control and status indication; the wireless communication including but not being limited to Wi-Fi internet communication; the plurality of weight measuring transducers located within feet members located on the underside of said housing, sending pressure values indicative of weight measurements to the microcontroller where the pressure is converted into an indication of the volume of wax remaining in the wax holding pot; the touch screen programmed to allow a user to preset temperature settings of the heated wax; the outer housing including a lid holding member for removably retaining the removable lid; the wireless communication capable of receiving a signal from a cell phone or other electronic device to remotely control the temperature settings of the wax in the holding pot.

### BRIEF DESCRIPTION OF THE DRAWINGS

The drawings constitute a part of this specification and include exemplary embodiments to the instant invention, which may be embodied in various forms. It is to be understood that in some instances various aspects of the instant embodiments may be shown exaggerated or enlarged to facilitate an understanding of the instant exemplary embodiments.

FIG. 1 is a front perspective view of the invention.

FIG. 2 is a rear perspective view of the invention.

FIG. 3 is a perspective view of the invention showing the lid removed and place in the lid holder.

FIG. 4 is an underside view of the invention.

FIG. 5 is a partial perspective view of the transducer assembly.

FIG. 6 is an exploded view of the touch screen assembly.

FIG. 7 is a plan view of the touch screen graphic showing temperature reading and weight reading.

FIG. 8 is a plan view of the touch screen graphic showing wax consistency and command options.

FIG. 9 is a perspective view showing internet connectivity.

FIG. 10 is a perspective view showing the temperature sensor and the heater.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

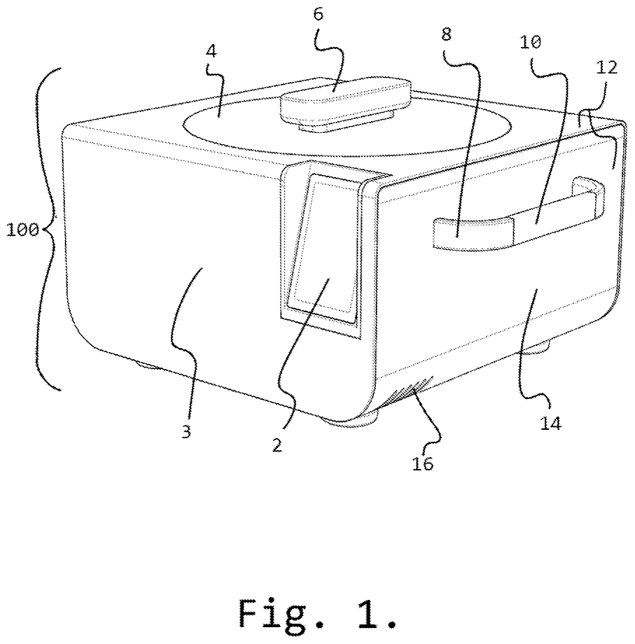

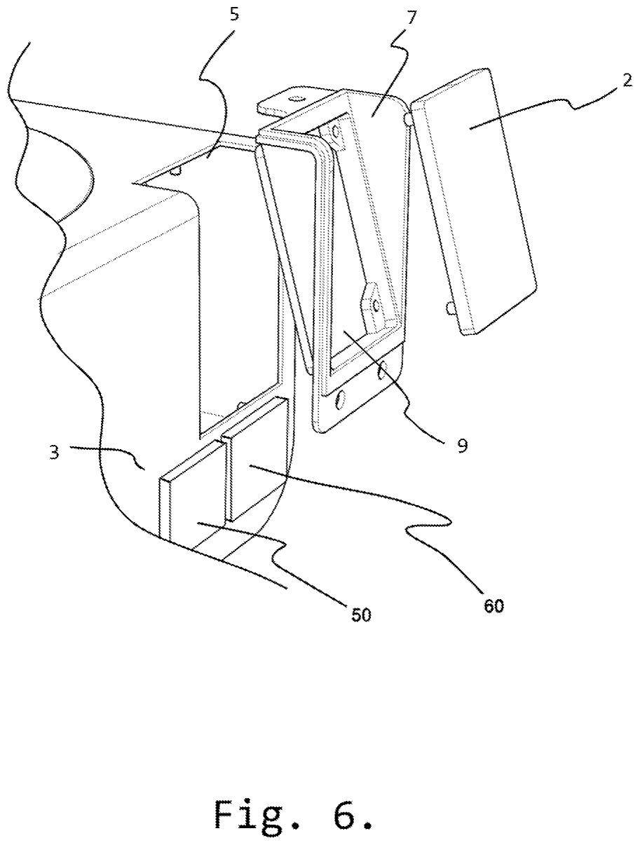

Referring now to FIG. 1 we see a front perspective view of the embodiment 100. An outer housing 12 is comprised of a bent front, top and rear panels 3 and a bent right side, left side and bottom panels 14. The top panel retains a removable lid 4 with a temperature resistant handle 6. Left and right side handles 8 also include temperature resistant overcoat material 10. Touch screen 2 is supported by a support member 7 as shown in FIG. 6. Air vents 16 help release heat from the interior of the housing 12.

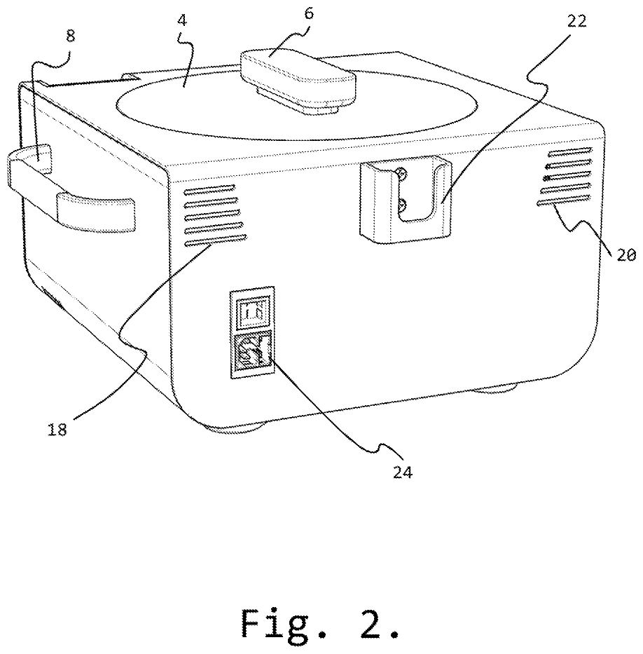

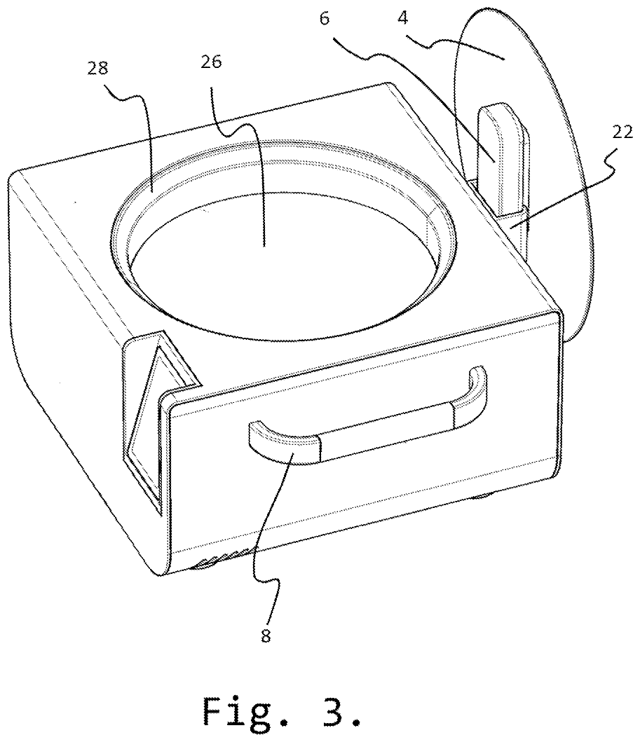

FIG. 2 is a rear perspective view of the embodiment 100. Utility power plug and a master on-off switch 24 provide utility power, 120 VAC in USA, to the heating element that is located in close proximity to the underside of metal heating pot 28 shown in FIG. 3. Utility power is also supplied to control and communication power supply, not shown to power the control system unit and the communication unit. Air vents 18, 20 help to remove heated air from the inside of the housing 12. Lid 4 holding component 22 is clearly shown.

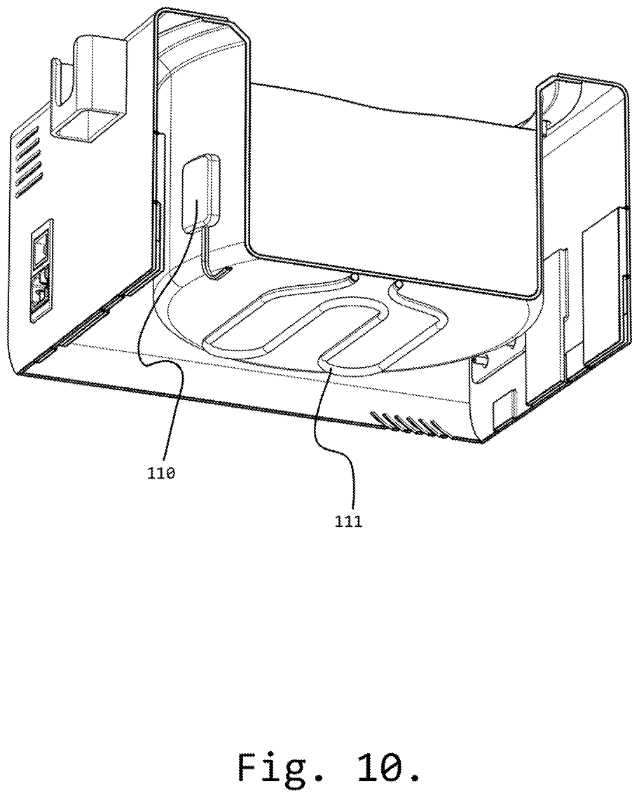

FIG. 3 is a perspective view of the embodiment 100 with the lid 4 removed and held via handle 6 to lid holding component 22. Metal wax holding pot 28 is clearly shown holding a quantity of wax, shown with wax level 26. The wax is in a solid state when not heated and in a viscous state when heated. The pot 28 is heated by a standard heating element 111, shown in FIG. 10, that is affixed to housing near the underside of the pot base.

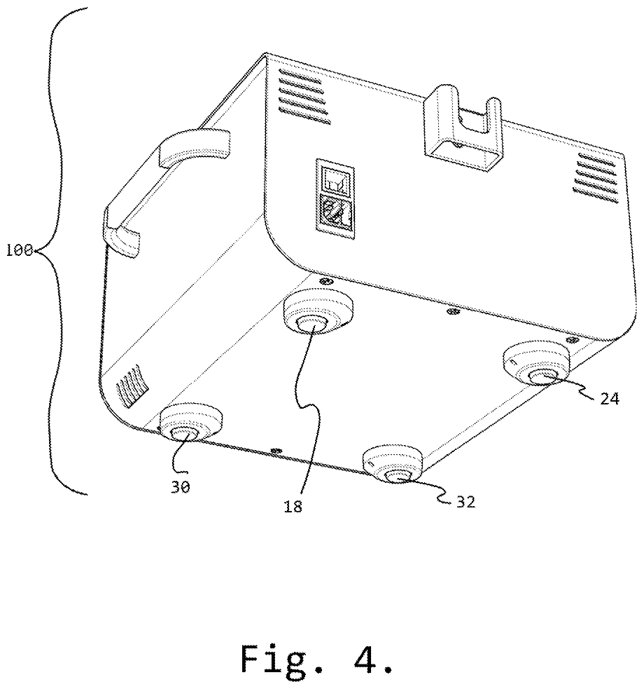

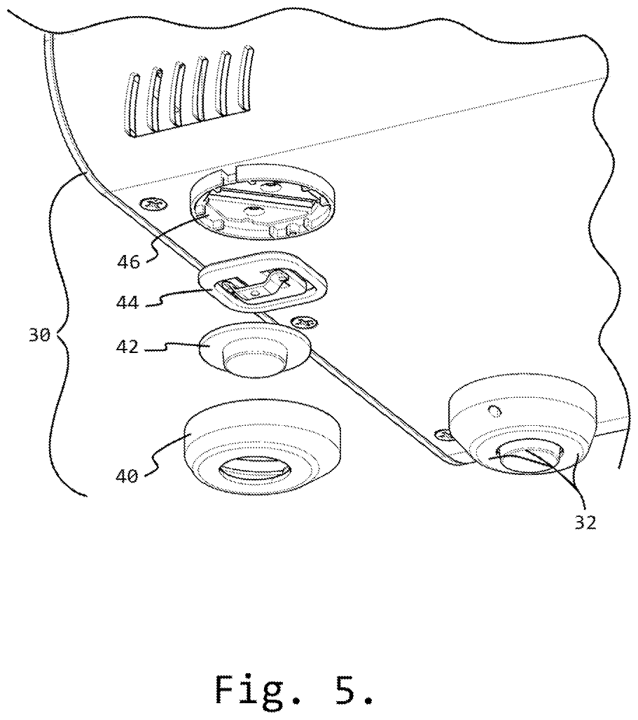

FIG. 4 is a perspective view of the underside of the embodiment 100. Feet 18, 24, 30, 32 support the entire unit 100 and also house pressure transducers 44 as shown in FIG. 5.

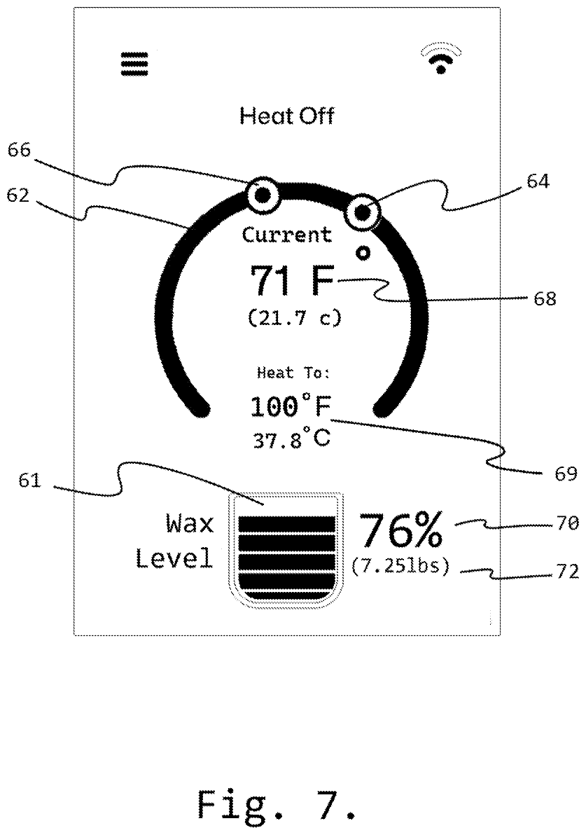

FIG. 5 is an exploded view of one foot 30. Transducer cover 42 is supported by surround cap 40. The cap 40 locks into receiving member 46. When fully assembled, the weight of the entire unit 100 is sensed by the four pressure transducer assemblies 18, 24, 30, 32 and translated into volume of wax retained in the hot pot 28, shown in FIG. 7, by the programmable control system unit 60 shown in FIG. 6. The weight is graphically represented by horizontal bars 61 and a numerical percentage number 70 and actual weight number 72 located on touch screen 2 as shown in FIG. 7.

FIG. 6 is an exploded view of the touch screen 2 ready to be inserted into a custom touch screen retainer 7 which also holds a microprocessor housing 9. The touch screen retainer 7 is attached to the housing front panel 3 via screws to reside within cutout area 5 in the housing wall 3. The angle of the touch screen with respect to the housing 3 makes it easier to see and easier to use.

FIG. 7 shows a view of a graphic panel on said touch screen 2. Partial circle 62 includes one indicator 66 that shows current temperature and one indicator 64 that shows desired temperature. The current temperature value 68 and the desired temperature 69 are displayed both numerically and graphically as shown. The wax level is shown in bars 60 and in actual percentage number 70 as well as pounds of wax remaining 72. These numbers are derived from the microprocessor 9 receiving weight measurements from transducers 44 and translating the measurements into a function of weight based on the established weight of wax used for hair removal.

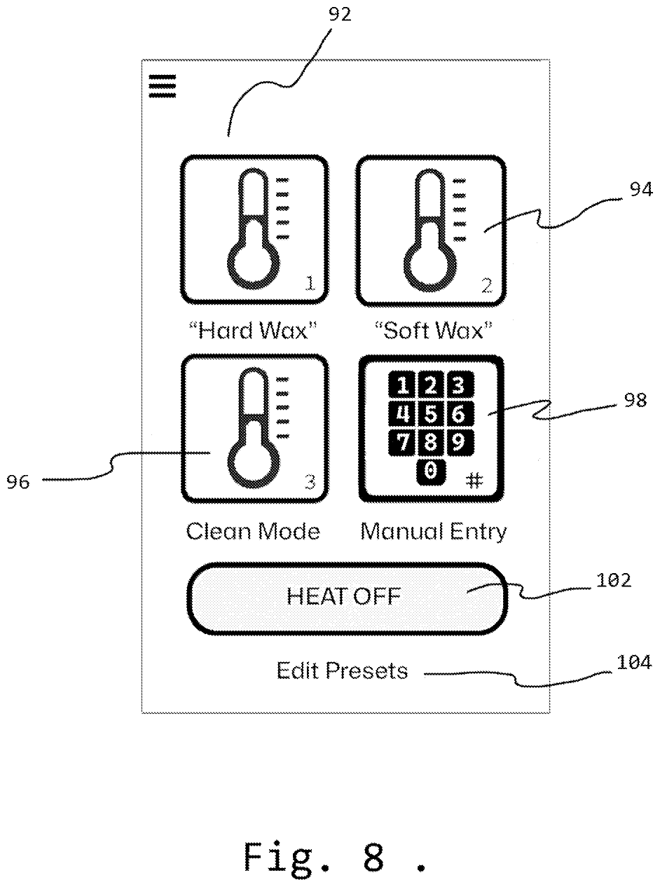

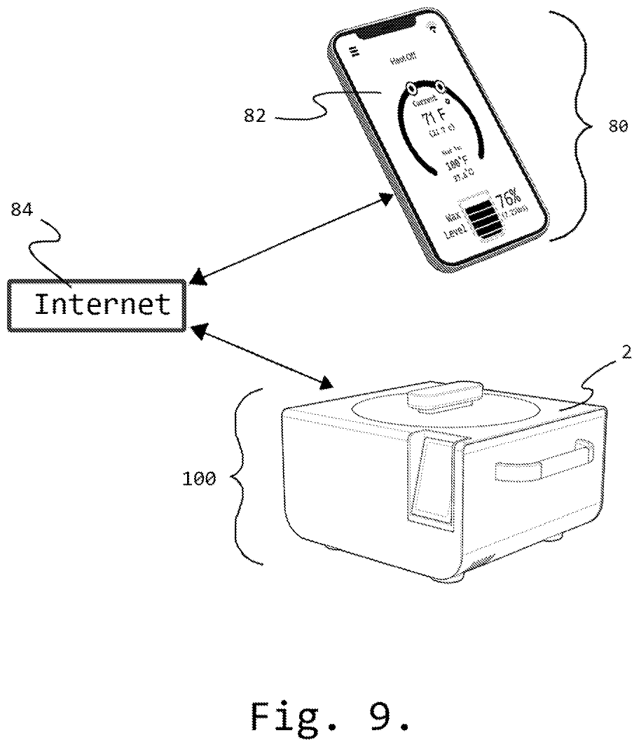

FIG. 8 shows a second graphic which can appear on the touch screen 2 where temperature icons 92, 94, 96 can be preset by the user so that the temperature and the consistency for hard wax, soft wax, or cleaning mode temperature can be set by simply pressing on the appropriate verbal icon relating to that function. If the user has a special temperature that needs to be set, he or she can press the desired temperature on the manual entry icon 98. The preset values can be modified by pressing the “Edit Presets” icon 104. The heating element can be completely turned on or off by pressing the “heat off” icon 102. These graphic panels can be seen and adjusted on touch screen 2 or on the touch screen 82 of user's cell phone 80 as shown in FIG. 9.

FIG. 9 is a simplified schematic of the wax warmer device 100 remote control concept wherein the wirelessly controllable wax warmer device 100 being controlled by the user's remote control operator 80 via a wireless communication network 84.

In most cases a smartphone will be used as the remote control operator, and any computer, tablet, smartwatch, or other device equipped with communication hardware and software compatible with the wax warmer remote communication implementation can be used to control the wax warmer device 100 via internet or via Bluetooth®. The wax warmer device 100 remote communication hardware and software may instead, or in addition, include near field wireless communication, and other communication networks and protocols, such internet of things, aka IoT.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

In the claims, the word ‘comprising’ does not exclude the presence of other elements or steps than those listed in a claim. Furthermore, the terms “a” or “an,” as used herein, are defined as “one, or more than one.” Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are arbitrarily used to distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

What is claimed is:

1. A self-contained in situ and remotely controllable appliance for melting a wax, and controlling the melted wax temperature, the appliance comprising:
an inner metal wax holding pot;
an outer housing;
the outer housing further comprising: a plurality of side panels, an underside panel, and a top panel, wherein the plurality of side panels together with the underside panel and with the top panel form a hollow housing, wherein furthermore each panel comprises an inside surface and an outside surface, the outside surfaces facing outward from the appliance, the top panel furthermore comprising an opening capable of accepting the inner metal wax holding pot;
the inner metal wax holding pot having an open top, the inner wax holding pot being removably and completely insertable into the outer housing surrounded by the plurality of side panels and the underside panel while being open at the top;
a removable lid, the removable lid capable of covering the wax holding pot open top;
a plurality of feet disposed on the outside surface of the underside panel;
a programmable control system unit, the programmable control system unit comprising a microcontroller with built-in CPU, memory and input and output circuitry;
a remote information display and control device;
a communication system unit, the communication system unit comprising at least one communication modem facilitating a bidirectional communication with the remote information display and control device, and a bidirectional communication interface to the programmable control system unit;
the programmable control system unit and the communication system unit disposed within the hollow housing;
a control and communication interface comprising a touch screen, the touch screen comprising a command and an information data input graphical interface, the touch screen further comprising an information data output graphical interface, wherein said information data input graphics and said information output data graphics facilitate a communication between a user, the programmable control system unit and the communication system unit, wherein furthermore the information data input graphical interface, and the information data output graphical interface is duplicated on the remote information display and control device;
at least one heating element disposed within the housing in close proximity to the wax holding pot bottom, wherein the heating element power being modulated by the programmable control system unit;
at least one temperature sensor touchingly disposed on the wax holding pot outside surface, wherein the temperature sensor being a thermistor in electrical communication with the control system unit and the communication system unit;
at least one pressure transducer each pressure transducer disposed within one of the plurality of feet, wherein each pressure transducer being in electrical communication with the programmable control system unit; and
a utility power input hardware for providing a heating power and powering the programmable control system unit and the communication system unit.

2. The self-contained appliance of claim 1, wherein the programmable control system unit microcontroller:
a. accepts a user input of a desired wax temperature value entered via the remote device or via the touch screen;
b. converts the thermistor electric output into a temperature value of the wax in the wax holding pot, displaying on the touch screen the temperature value as a temperature numeric value and as a temperature graphical value;
c. transmits the temperature numeric value to the remote device via the communication system unit;
d. converts the pressure sensors electric outputs into a weight value, displaying on the touch screen the weight value as a weight numeric value and as a weight graphical display value;
e. transmits the weight numeric value to the remote device via the communication system unit; and
f. accepts the user input to turn the wax warming appliance ON or OFF.

3. The self-contained wax warming appliance of claim 2, wherein the programmable control system unit microcontroller compares the user input of the desired temperature value with the melted wax temperature value whereby the microcontroller modulates a power flow to the heating element to maintain the desired melted wax temperature.

4. The self-contained wax warming appliance of claim 3, wherein the power flow to the heating element is electric power.

5. The graphical display of claim 2 configured to display:
a. the desired wax temperature value and the current wax temperature numerically and graphically;
b. an amount of the wax in the pot graphically and numerically as a percentage of the pot volume and numerically in mass units; and
c. a status of wax consistency in the pot graphically as a bar diagram and verbally.

6. The graphical display of claim 2 further comprising a state wherein the user can configure and display and:
a. accept the desired wax temperature using a numeric keyboard on the touch screen;
b. accept a heating element on or off command using an icon on the touch screen; and
c. enable editing using an icon on the touch screen.

7. The self-contained appliance of claim 1, wherein the outer housing comprises: a cylindrical side panel, a circular underside panel, and a circular top panel, wherein the cylindrical side panel together with the circular underside panel and with the circular top panel form a hollow housing, wherein furthermore each panel comprises an inside surface and an outside surface, the outside surfaces facing outward from the appliance, the top panel furthermore comprising an opening capable of accepting the inner wax holding pot.
